(19) United States
(12) Patent Application Publication
(10) Pub. No.: US 2026/0295738 A1
(43) Pub. Date: Oct. 1, 2026

(54) DEVICE AND METHOD FOR WELDING HALF SHEETS TO FORM A BIPOLAR PLATE

(71) Applicant: Schaeffler Technologies AG & Co. KG, Herzogenaurach (DE)

(72) Inventors: Maximilian Welker, Feucht (DE); Volker Benz, Herzogenaurach (DE)

(73) Assignee: Schaeffler Technologies AG & Co. KG, Herzogenaurach (DE)

(21) Appl. No.: 19/483,240

(22) PCT Filed: Apr. 17, 2024
(86) PCT No.: PCT/DE2024/100327

§ 371 Date: Nov. 11, 2025

(30) Foreign Application Priority Data
May 11, 2023 (DE) 10 2023 112 406.4
Apr. 16, 2024 (DE) 10 2024 110 648.4

(51) Int. Cl. B23K 37/04; B23K 15/00; B23K 26/24; B23K 101/04; B23K 101/38

(52) U.S. Cl. CPC B23K 37/0408; B23K 15/0053; B23K 26/24; B23K 37/0443; B23K 2101/045; B23K 2101/38

(57) ABSTRACT

A device and a method for welding half sheets to form a bipolar plate are provided. The device includes at least three tool parts: a lower tool part and a multi-part upper tool part. The half sheets are inserted between these parts. The multi-part upper tool part includes a plurality of individual parts arranged one after the other and only alternately above the lower tool part. Each individual part of the multi-part upper tool part has a first opening for the introduction of pressurized gas, through which the half sheets can be pressed against one another, and a second opening for the introduction of joining energy during a welding process for welding the half sheets. A shape of the second openings in the individual parts is complementary to one another as viewed perpendicular to the plane of the half sheets and only overlaps in certain areas.

### CROSS-REFERENCE TO RELATED APPLICATIONS

This application is the United States National Phase of International Application PCT/DE2024/100327, filed Apr. 17, 2024, which claims priority to German Application 10 2024 110 648.4, filed Apr. 16, 2024 and to German Application 10 2023 112 406.4, filed May 11, 2023. The disclosures of the above applications are incorporated herein by reference.

### TECHNICAL FIELD

The disclosure relates to a method for welding half sheets to form a bipolar plate for a stack of electrochemical cells. Furthermore, the disclosure relates to a device suitable for carrying out such a method.

### BACKGROUND

CN 112388166 A discloses various devices with which bipolar plates can be fixed during laser welding. Tool systems that combine a lower tool part with an upper tool part are assumed to be known here. In this context, the welding process is carried out from both sides of the bipolar plate with two laser units through openings in the lower tool part and upper tool part.

A device described in CN 113967805 B is intended to enable ultra-thin sheets to be held in place during laser welding. This device includes a bottom plate and a plurality of other plates, where individual components of the device are movably coupled to one another.

A laser welding device for separators of fuel cells made up of half sheets is known from KR 102241379 B1, which has a main block with recesses as fastening contours. Here, two or more so-called island-shaped blocks are to be mounted on the main block. In the main block, i.e., the lower tool part, there are openings that open into the region of media flow openings in the half sheets to be welded. Inert gas can be fed through these openings during welding. The inert gas is used to reduce or prevent oxidation of the weld seam.

KR 20130025527 A describes a device and a method for holding separator plates for fuel cells in place during welding, where a vacuum is used to fix the components.

CN 108838240 A discloses the automated forming and welding of metallic bipolar plates, which are constructed according to the “two plates, three fields” scheme. Resistance welding is suggested as the welding method in this case. Shielding gas is also to be used here.

When welding metal sheets in the production of bipolar plates, the clamping technology employed is essential in order to press the sheets together without any gaps. A defect-free welding process is only possible if the metal sheets lie directly on top of one another, i.e., without a gap in between. If this is not the case and a gap exists between the metal sheets that is greater than approximately 10% of the sheet thickness, the molten metal formed sags during welding and holes are created. For weight reasons, the technical development trend is moving towards ever thinner sheet thicknesses, in the case of which this effect is even more pronounced.

### SUMMARY

The disclosure provides possibilities for welding bipolar plates for electrochemical systems that have been further developed compared to the aforementioned prior art and provides a particularly high degree of process reliability and precision.

One aspect of the disclosure provides a device for welding half sheets of a bipolar plate and a method for welding the half sheets of a bipolar plate.

The device for welding half sheets to form a bipolar plate includes at least three tool parts, namely a lower tool part and a multi-part upper tool part, where the half sheets to be welded together can be inserted between the lower tool part and the multi-part upper tool part. The multi-part upper tool part includes multiple individual parts which can be arranged one after the other and only alternatively above the lower tool part, where in each of the individual parts of the multi-part upper tool part both at least one first opening for the introduction of pressurized gas, through which the half sheets can be pressed against one another, and at least one second opening for the introduction of joining energy during a welding process for welding the half sheets, are formed. A shape of the second openings in the individual parts of the multi-part upper tool part, as viewed perpendicular to the plane of the half sheets, is designed to be largely complementary to one another and only overlapping in regions, such that only a portion of an overall weld to be formed can be produced in each case using an individual part of the multi-part upper tool part.

A “half sheet” is understood here to be a thin metal foil, for example with a thickness in the range of ≤100 μm. In the undeformed state or in regions that are not three-dimensionally deformed, such metal foils are pliable and difficult to handle. Multiple such half sheets can be welded together to form a bipolar plate, such as two half sheets can be welded together. However, there can also be multiple half sheets, for example three half sheets.

The time-delayed application of the weld seams on the half sheets, which is achieved by changing the different individual parts of the multi-part upper tool part, results in the thermal stress on the thin half sheets being reduced locally and the overall quality of the weld seams and the bipolar plate being improved. Fewer welding defects, such as the formation of holes, occur, where a series production of high quantities of bipolar plates is made possible with the device according to the disclosure.

The lower tool part, which is not provided with openings, has a comparatively simple shape, while the multi-part upper tool part has a much more complex design.

The various first and second openings, which serve different purposes, are located in the individual parts of the multi-part upper tool part.

In some examples, multiple first openings are present, which are distributed on the respective individual part in order to ensure that the half sheets are pressed together over a large area.

The second openings of each individual part allow only a portion of all the weld seams required to form the bipolar plate to be formed. This allows the half sheet arrangement to cool down again while the individual parts are being changed before the next welding process starts.

Multiple mutually interchangeable multi-part upper tool parts can be assigned to a single lower tool part. In this context, the multi-part upper tool parts are designed in such a way that no individual part of a multi-part upper tool part alone, but only the entirety of the individual parts of the respective multi-part upper tool part to be combined with the lower tool part, specifies the position of all weld seams that connect the half sheets to one another.

In some examples, the second openings in the individual parts of the multi-part upper tool part have a V-shaped cross-section widening in the direction away from the lower tool part. This makes the welding process easier.

In some examples, a first individual part and a second individual part together form the multi-part upper tool part. However, three or more individual parts can also form a corresponding multi-part upper tool part.

In some implementations, the individual parts of the multi-part upper tool part have, on their side facing the lower tool part, multiple raised pressure stamps which adjoin the second openings. This produces a good contact pressure between the half sheets so that a continuous and firm weld seam can be formed during the welding process.

Depending on the geometric design of the bipolar plate, either one half sheet or each half sheet can have a three-dimensional structuring. The three-dimensional structuring of the half sheets is introduced, for example by embossing, prior to the welding process. In this regard, the half sheets are not necessarily formed as completely mirror-symmetrical to one another. The structuring leads to greater rigidity and thus better handling in the formed regions of a half sheet. Nevertheless, the undeformed regions remain pliable and the deformed regions are still easily deformable so that they can be pressed against one another by the gas flow.

In some implementations, the method for welding half sheets to form a bipolar plate by way of a device assumes that an arrangement of half sheets lying on top of one another is welded together by inserting the half sheets between the lower tool part and a first individual part of the multi-part upper tool part. Pressurized gas is passed through the at least one first opening in the first individual part, with which the half sheets are pressed against one another, where at the same time joining energy for welding the half sheets is introduced through at least one second opening located in the first individual part and a first portion of weld seams is formed. The first individual part is then exchanged for at least one second individual part of the multi-part upper tool part in such a way that pressurized gas is passed through the at least one first opening in at least one second individual part, with which the half sheets are pressed against one another. At the same time, joining energy for welding the half sheets is introduced through at least one second opening located in the second individual part and a further portion of weld seams is formed.

The method allows for a fast and high-quality series production of bipolar plates.

Compressed air or an inert gas can be used as the pressurized gas.

Each individual part of the multi-part upper tool part is pressed against the half sheets and the lower tool part during the execution of the method. In some examples, the optional pressure stamps on the first individual part and on the at least one second individual part press the half sheets against the lower tool part.

This allows the gas flow from the at least one first opening to flow along between the individual part and the adjoining half sheet and, for example, to press the existing pliable regions of the half sheets against one another without gaps.

In some implementations, laser welding can be selected as the welding method. Depending on the materials from which the half sheets are made, a different welding method, such as electron beam welding, can also be considered.

Regardless of the choice of materials and welding method, the lower tool part can be arranged either on a rigid substructure or on a rotary table. In the latter case, the individual parts of the respective multi-part upper tool part are comparatively less movable so that they are provided as almost static components. It is precisely this quasi-static arrangement of the individual parts of the multi-part upper tool part that facilitates the supply of compressed air or gas to these individual parts. The first openings, through which pressurized gas is to be supplied, can be located in any region of the bipolar plate, for example in the active field and/or in port regions.

The device for welding half sheets to form a bipolar plate is suitable for producing gas-tight joints between thin half sheets. Such a metal sheet may be made of steel, such a stainless steel, or titanium. Here, the sheet thickness, i.e., the thickness of a half sheet, can be ≤100 μm, for example 75 μm or even less. Such a half sheet is therefore more of a metal foil. An optional coating can always be applied to a half sheet either prior to welding or after welding.

In any case, subjecting one of the half sheets to compressed air or another pressurized gas, such as inert gas, compensates for geometric inaccuracies so that the regions of the thin half sheets to be welded together are positioned on top of one another practically gap-free during the welding process.

In some implementations of the method, welding is followed by a leak test, where the same pressurized gas source that was previously used to press the half sheets together can be used for this.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a device for welding half sheets to form a bipolar plate,

FIG. 2 shows a top view of the shape of weld seams of a bipolar plate produced with the device according to FIGS. 1, 3 and 4, and

FIGS. 3 and 4 each show an individual part of the multi-part upper tool part to be combined with a lower tool part of the device according to FIG. 1.

Like reference symbols in the various drawings indicate like elements.

### DETAILED DESCRIPTION

A production system designated overall with the reference sign 12 includes a device 5 which is used for welding half sheets 2, 3 of a bipolar plate 1. The production system 12 includes the device 5 as well as a welding device 13 suitable for welding metal sheets, here in the form of a laser of a type known per se.

The device 5 includes a lower tool part 6a and a multi-part upper tool part 6b, which here includes a first individual part 7 and a second individual part 8. During operation of the production system 12, the lower tool part 6a is located on a substructure 14, which in the present case is a rotary table.

Even before the half sheets 2, 3 made of sheet steel, such as stainless steel, were inserted into the tool or device 5, three-dimensional structurings 4 were produced in the half sheets 2, 3 in an upstream production step. The structuring 4, in this case an embossing, of the half sheets 2, 3 can be carried out using any continuous and/or discontinuous methods known per se. Alternatively, it is possible to perform at least part of the forming of the half sheets 2, 3 using the tool or device 5.

A cavity through which a coolant-more generally: a heat transfer medium can flow within the subsequent cell stack, which includes a plurality of bipolar plates 1 of the type outlined, is formed between the half sheets 2, 3 by way of the structuring 4.

Depending on the operating phase of an electrochemical cell stack and the ambient conditions, the cell stack can also be heated by the heat transfer medium. In the present case, the electrochemical cell stack is, for example, a fuel cell stack. Alternatively, the electrochemical cell stack can be designed as an electrolyzer for hydrogen production, for example. Operating media of the electrochemical cells flow on the outer surfaces of the bipolar plate 1, i.e., on the outer sides of the half sheets 2, 3, within the later end product.

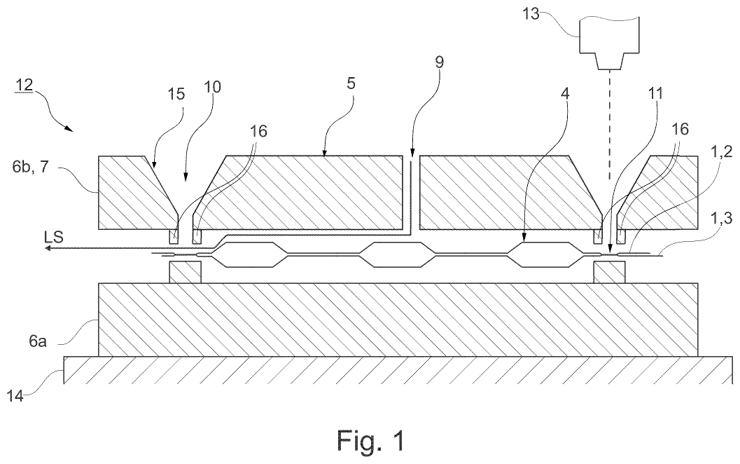

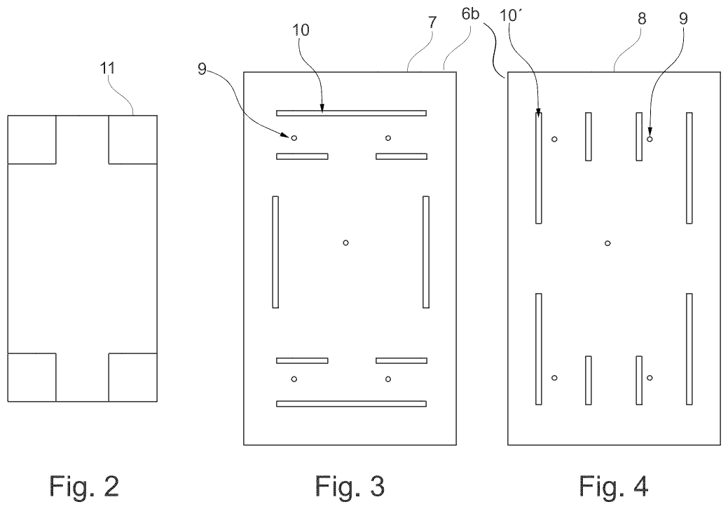

As can be seen in FIG. 1, the lower tool part 6a has a simple shape in which there are no openings intended for the supply of pressurized gas or for the input of energy during welding. The freedom from openings does not apply to holes, which may be present for positioning pins or screw connections, for example. In contrast to the lower tool part 6a, there are multiple first openings 9 in the upper tool part 6b or in the first individual part 7 and second individual part 8, which can be used for the introduction of pressurized gas, and multiple second openings 10, 10′ (see also FIGS. 3 and 4) of various shapes, which can be used for welding.

At various points on the individual parts 7, 8 there are first openings 9, i.e., holes intended for the supply of pressurized gas. Holes arranged in the central region of the individual parts 7, 8 and thus also of the half sheets 2, 3 allow for the introduction of a pressurized gas, such as compressed air to form an air flow LS, into the region of the later active field of the bipolar plate 1. Holes located further outside on the individual part 7, 8 (see FIGS. 3 and 4), on the other hand, are used to supply pressurized gas to port regions of the bipolar plate 1.

Overall, the top half sheet 2 is pressed against the bottom half sheet 3 by the pressurized gas, which is supplied through the first openings 9 into the volume between the respective individual part 7, 8 and the half sheet 2, so that any gaps between the half sheets 2, 3 disappear completely or almost completely in regions in which the half sheets 2, 3 are to be welded together. The pressure to which the air flow LS is subjected must be selected in such a way that no undesirable plastic deformation of the half sheets 2, 3 occurs.

Spatially separated from the described first openings 9, which serve to supply gas, each of the individual parts 7, 8 of the multi-part upper tool part 6b has second openings 10, 10′, which allow for the half sheets 2, 3 to be welded. In FIG. 1, the laser 13 used for welding is directed at one of the second openings 10 of the first individual part 7 in order to produce a weld seam 11. As can also be seen from FIG. 1, the second openings 10 that allow for the welding have a V-shaped cross-section that widens upwards, i.e., in the direction of the laser 13. The V-shape is adjusted such that the laser beam can be incident on the workpiece, i.e., the bipolar plate 1, at an angle and converge conically towards a defined point in a focused manner.

All second openings 10, 10′ have a straight slot shape in the simplified example shown in the sketched top view (see FIGS. 3 and 4), which is accompanied by a straight shape of the subsequent weld seams 11. In fact, more complex shapes of the weld seams 11 exist. In some examples, sections of the weld seams 11 can be curved or inclined relative to the outer contours of the half sheets 2, 3.

FIG. 2 shows the overall shape of the weld seams 11 connecting the half sheets 2, 3. Part of this overall shape is predetermined by the shape of the slot-like second openings 10 in the first individual part 7 outlined in FIG. 3. After a portion of the weld seams 11 has been produced using the first individual part 7, it is exchanged for the second individual part 8. This is achieved by rotating the rotary table with the lower tool part 6a and the already partially welded half sheets 2, 3 under the second individual part 8.

As a comparison of FIGS. 3 and 4 shows, the shape of the openings 10′ in the second individual part 8 is largely complementary to the openings 10 in the first individual part 7. The openings 10, 10′ partially overlap. Overall, the successive application of the two individual parts 7, 8 results in the overall shape of the weld seams 11 recognizable in FIG. 2. There exist optional fixing means, not shown, that serve to prevent any change in position of the half sheets 2, 3 or the partially finished bipolar plate 1 in production when changing the individual parts 7, 8.

Furthermore, method variants can also be realized with the device 5, in which a plurality of half sheets 2, 3 of uniform design are initially partially welded using a first individual part 6b. After processing such a batch of half plates 2, 3, the first individual part 7 is exchanged for a second, different individual part 8 and the welding process is completed. In this case, positioning contours must be provided on the lower tool part 6a and on at least one of the half sheets 2, 3, which ensure that the half sheets 2, 3 are positioned in a precisely defined position during each welding process.

Method variants can also be realized in which a plurality of half sheets 2, 3 of uniform design are initially partially welded using a first multi-part upper tool part 6b. After processing such a batch, the first multi-part upper tool part 6b is exchanged for a second, different multi-part upper tool part 6b and a plurality of half sheets 2, 3 of a uniform, but different designs are welded using the second multi-part upper tool part 6b. In this case, positioning contours must also be provided on the lower tool part 6a and on at least one of the half sheets 2, 3, which ensure that the half sheets 2, 3 are positioned in a precisely defined position to form different bipolar plates 1 during each welding process.

A number of implementations have been described. Nevertheless, it will be understood that various modifications may be made without departing from the spirit and scope of the disclosure. Accordingly, other implementations are within the scope of the following claims.

### REFERENCE NUMERALS

1 Bipolar plate
2 Half sheet
3 Half sheet
4 Structuring
5 Device
6a Lower tool part
6b Multi-part upper tool part
7 Individual part of the multi-part upper tool part
8 Individual part of the multi-part upper tool part
9 Opening for air supply
10 Opening for welding
10′ Opening for welding
11 Weld seam
12 Production system
13 Welding device, laser
14 Substructure
15 Flank
16 Pressure stamp
LS Gas flow

1. A device for welding half sheets to form a bipolar plate, the device comprising:
at least three tool parts, including a lower tool part and a multi-part upper tool part,
wherein the half sheets inserted between the lower tool part and the multi-part upper tool part,
wherein the multi-part upper tool part comprises multiple individual parts arranged one after the other and alternatively above the lower tool part,
wherein each of the individual parts of the multi-part upper tool part includes:
at least one first opening for receiving pressurized gas, through which the half sheets can be are pressed against one another, and
at least one second opening for receiving joining energy during a welding process for welding the half sheets,
wherein a shape of the second openings in the individual parts of the multi-part upper tool part, as viewed perpendicular to a plane of the half sheets is designed to be largely complementary to one another and overlap in certain regions, such that only a portion of an overall weld to be formed can be produced in each case using an individual part of the multi-part upper tool part.

2. The device of claim 1, wherein the second openings have a V-shaped cross-section widening in a direction away from the lower tool part.

3. The device of claim 1, wherein multiple mutually interchangeable multi-part upper tool parts are combined with the lower tool part.

4. The device of claim 3, wherein a totality of the second openings in the individual parts of the multi-part upper tool part specify a position of all weld seams for joining the half sheets.

5. The device of claim 1, wherein a first individual part and at least one second individual part together form the multi-part upper tool part.

6. The device of claim 1, wherein the individual parts of the multi-part upper tool part have, on their side facing the lower tool part, multiple raised pressure stamps which adjoin the second openings.

7. A method for welding half sheets to form a bipolar plate by way of a device, the method comprising:
providing an arrangement of half sheets lying on top of one another,
welding the arrangement of half sheets,
inserting the half sheets between the lower tool part and a first individual part of a multi-part upper tool part, and
passing pressurized gas through an at least one first opening in the first individual part, with which the half sheets are pressed against one another,
simultaneously introducing joining energy for welding the half sheets through at least one second opening located in the first individual part and forming a first portion of weld seams,
subsequently exchanging the first individual part for at least one second individual part of the multi-part upper tool part,
passing pressurized gas through the at least one first opening in at least one second individual part, with which the half sheets are pressed against one another, and
simultaneously introducing joining energy for welding the half sheets through at least one second opening located in the second individual part and forming a further portion of weld seams.

8. The method of claim 7, wherein pressure stamps on the first individual part and on the at least one second individual part press the half sheets against the lower tool part.

9. The method of claim 8, wherein the welding is carried out by means way of laser welding.

10. The method according to claim 8, wherein the welding is carried out by way of electron beam welding.
